(19) United States
(12) Patent Application Publication
(10) Pub. No.: US 2007/0232273 A1
(43) Pub. Date: Oct. 4, 2007

(54) Method of providing an electronic answering function to a wireless phone

(76) Inventor: Wei-Hao Huang, Taipei (TW)

Correspondence Address: HARNESS, DICKEY & PIERCE, P.L.C., P.O. BOX 8910, RESTON, VA, 20195, US

(21) Appl. No.: 11/395,288

(22) Filed: Apr. 3, 2006

(51) Int. Cl. H04L 12/58

(52) U.S. Cl. 455/412.1

(57) ABSTRACT

A method of providing an electronic answering function to a wireless phone includes steps of: setting time T1; receiving an incoming call signal from a transmitting end; automatically answering the incoming call signal with the wireless phone when the user does not answer within the time T1; and switching the wireless phone to a message-taking mode. Therefore, the wireless phone can directly answer the incoming call and take the message.

### BACKGROUND OF THE INVENTION

1. Field of Invention

The invention relates to a method of providing an electronic answering function to a wireless phone and, in particular, to a method of providing the message-taking function to a mobile phone.

2. Related Art

In the wireless communication era, people have largely used wireless communication products to communicate and exchange messages. In order to communicate at any time and any place, various kinds of portable wireless communication electronic devices such as mobile phones have been invented. It is therefore very common for each person to have at least one mobile phone in the modern society.

As shown in FIG. 1, the communication of a conventional mobile phone, such as the Global System for Mobile (GSM) Communication System, generally includes a first user 11, a system 12 of the service provider, and a second user 13, wherein the system 12 has a system message-taking module 122. The operation principle of the communication system in the conventional mobile phones is as follows.

The first user sends out a signal (step 21). When the first user 11 wants to communicate with the second user 13, a signal is sent out from the first user 11.

The system transfers the signal to the second user (step 22). After the first user 11 sends out the signal, it is first received by the system 12 and then transferred by the system 12 to the second user 13.

The incoming call signal is not answered within time T2 (step 23). In general, to provide more services for higher charges, the system 12 provides a voice message function to take messages. When the system 12 further sends the signal sent by the first user 11, the timer module 121 starts timing. If the second user 13 does not answer the incoming call signal within a specific time T2 (different among different service providers), then the system 12 starts the voice message service.

The system inquires whether to take a message (step 24). If the second user 13 does not answer the incoming call signal within time T2, the system 12 sends out an inquiry signal to the first user 11, asking whether to let the system take a message.

The system takes the message (step 25). If the first user 11 asks the system to take the message, then the message-taking function of the message-taking module 122 of the system 12 starts to take the message.

The system sends out a notification signal 26. After taking the message, the system 12 sends out a notification signal to the second user 13. By this, the system charges the first user 11 for a related service fee. Of course, such a charge can be billed in the form of conversation service as the system takes the message.

Listen to the message (step 27). When the second user 13 receives the notification signal sent out by the system 12, the second user 13 has to dial to the system 12 and enter the message-listening function of the system 12 if he or she wants to listen to the message. As the second user 13 listens to the message, the second user 13 also needs to pay the message-listening charge. Likewise, the message-listening charge can be billed in the form of conversation service.

Converse directly (step 28). If the second user 13 answers the phone within time T2, then the first user 11 and the second user 13 can have a conversation directly.

### SUMMARY OF THE INVENTION

The invention aims at solving the problem that in the conventional mobile system, if one makes a phone call and the receiver does not answer it the mobile phone automatically hangs up and the call is transferred to the system for taking a message. In this case, the caller has to pay for the message-taking. The receiver who does not answer this call has to pay the service provider for listening to the message. This kind of charges is very costly. Therefore, the invention is proposed to provide the electronic answering function to the wireless phone, saving a lot of cost to be paid to the service provider.

To achieve the above objective, the invention provides a method of providing an electronic answering function to a wireless phone. The method includes the steps of: setting time T1; receiving an incoming call signal from a transmitting end; automatically answering the incoming call signal with the wireless phone when the user does not answer within the time T1; and switching the wireless phone to a message-taking mode. Therefore, the wireless phone can directly answer the incoming call and take the message.

The above method may further include the step of sending out an incoming call notification. When the wireless phone receives an incoming call signal, a notification is first sent out to notify the user the incoming call. If the wireless phone is not answered by the user within time T1, the wireless phone answers the incoming call and switches the wireless phone to the message-taking function.

The invention achieves at least the following effects:

(1) The mobile phone is built in with the answering function. When listening to the message left by the caller, the receiver does not need to pay extra charges to the service provider. He or she can play the messages directly from the mobile phone.

(2) Once the mobile phone has the message-taking function, one may set up a black list. For phone calls from numbers in the black list, they are transferred automatically to the answering machine built in the mobile phone for the callers to leave messages. The user does not need to answer directly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a block diagram for the communication system of a conventional mobile phone;

FIG. 2 is a hardware block diagram of a normal mobile phone;

FIG. 3 is a flowchart of the disclosed method of providing an electronic answering function to a wireless phone; and

FIG. 4 is a flowchart of using the disclosed method in a mobile communication system.

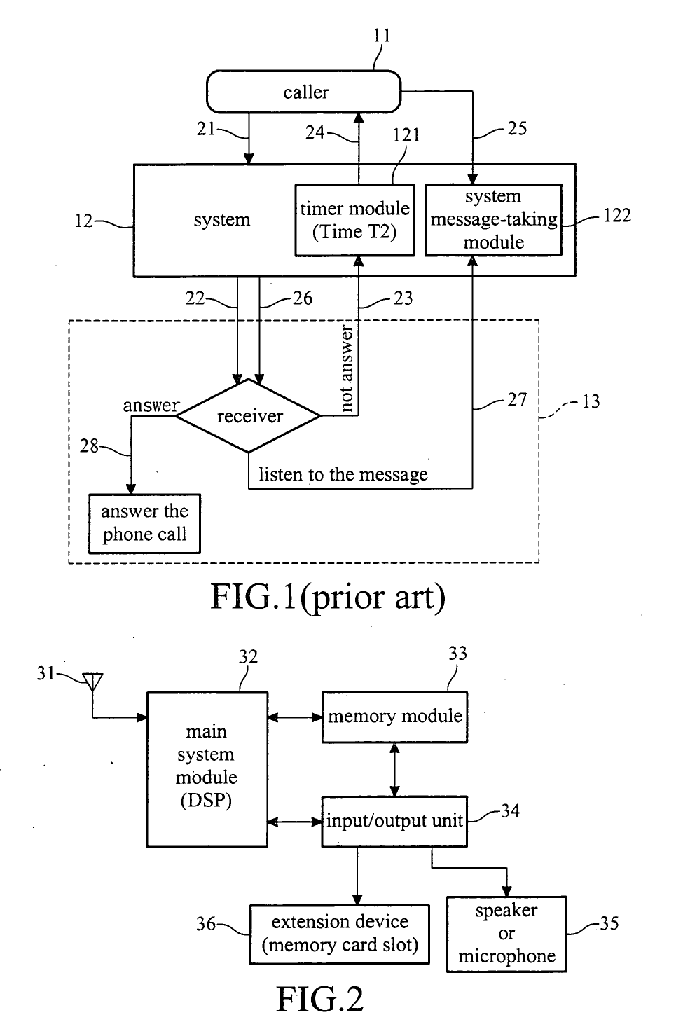

### DETAILED DESCRIPTION OF THE INVENTION

For the convenience of explaining the invention, the wireless phone in this embodiment is a mobile phone.

Currently, the mobile communication systems mostly used on the market are run by civilian service providers. The system message taking service provided by them is a very convenient function. The biggest drawback of this function is that the service provider starts to charge when a first user 11 (caller) decides to leave a message. When a second user 13 (receiver) listens to the system message, he or she has to pay for that too. This is really uneconomic. Recently, the mobile phones have much larger memory capacity. It therefore will be very convenient and economic if the mobile phones can be provided with the electronic answering function.

As shown in FIG. 2, the system block diagram of a normal mobile phone has: an antenna module 31, a main system module 32, and a memory module 33. The antenna module 31 is used as the signal connection in wireless communications with the system 12. The main system module 32 generally consists of a core with a digital signal processor (DSP). It has the function like the mainboard of a computer. When the antenna module 31 receives a signal emitted from the system 12, the main system module 32 decodes and converts the received radio signal into a digital signal or a voice signal for storage. Likewise, when the user emits a voice signal, the main system module 32 encodes the received voice signal and converts it into a radio signal to be emitted to the system 12. The memory module 33 may also store decoded voice data, in addition to the operating system and utilities required for the operation of the main system module 32.

In addition to the above-mentioned basic structure, a normal mobile phone is connected to a speaker or microphone 35 via an input/output unit 34 for the convenience of the user to have conversations. However, the current mobile technology is quite mature; each mobile phone can be coupled to many extension devices 36, such as the memory card slot. Using the memory card slot, the mobile phone has a larger capacity to store incoming call messages. Therefore, it becomes more practical to use the mobile phone to store incoming call messages.

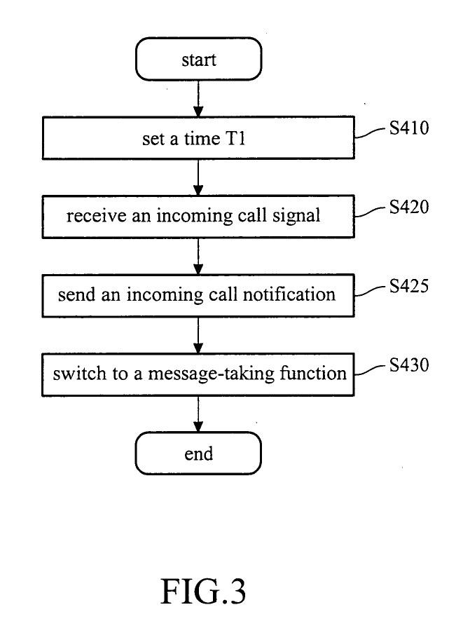

FIG. 3 shows the procedure in the disclosed method used on a second user 13 (i.e., the receiver). It includes the following steps.

Step S410: set a time T1 on the wireless phone of the second user 13. The time T1 is used as a standard to determine whether the wireless phone of the second user 13 should enter a message-taking function.

Step S420: receive an incoming call signal. The incoming call signal is the in coming call signal from the system 12. Once the time T1 on the wireless phone of the second user 13 is set, the wireless phone of the first user 11 emits a signal if the first user 11 wants to communicate with the second user 13. The signal is received by the system 12, and the system 12 transfers it to the wireless phone of the second user 13. The signal sent by the system 12 to the second user end 13 is the incoming call signal received in this step.

Step S425: send an incoming call notification. When the wireless phone of the second user 13 receives the incoming call signal in step S420, it notifies the user about the incoming call by rings or vibrations. However, if the user sets the wireless phone in the silent mode or sets the time T1 as 0 second in step S410, then this step can be skipped.

Step S430: when the wireless phone of the second user 13 is not answered by the user within the time T1, the wireless phone of the second user 13 automatically connects to the system 12 so that the first user 11 can communicate with the second user 13 via the system 12. At the same time, the wireless phone of the second user 13 is switched to a message-taking function. The message-taking function of the wireless phone of the second user 13 stores the voice signal of the caller in a memory module 33. The memory module 33 can be non-volatile memory. The voice signal of the caller may also be stored in an extension device 36, such as a memory card slot with a secure digital (SD) card, a compact flash (CF) card, a memory stick (MS) card, or a smart media (SM) card.

The system 12 has a system message-taking function. After the system 12 sends out the signal to the second user 13 and if the wireless phone of the second user 13 is not answered within time T2, the system 12 cuts the connection between the system 12 and the second user 13 and asks the first user 11 whether to leave a message. In order for the wireless phone of the second user 13 to have the function of taking messages, the time T1 on the wireless phone of the second user 13 has to be set to be less than the time T2 on the system 12 (time T1<time T2). Only in this way can the wireless phone of the second user 13 starts its message-taking function before the system 12 breaks the connection with the second user. The time T1 is set according to the user's preference. For example, if the phone is in the sleep mode, the conference mode, or the incoming call is made by a person in the black list, then the time T1=0 directly. This means that the wireless phone enters the message-taking function whenever there is an incoming call. Suppose the system 12 sets the time T2=15 seconds, then the wireless phone of the second user 13 can be set with T1=14 seconds. In this case, the second user 13 has at least 13 seconds to pick up the wireless phone. Of course, if the system 12 has the time T2=15 seconds, then the wireless phone of the second user 13 can have the time T1 between 0 and 13 seconds for the second user 13 to pick up the phone.

The invention may be used in a wireless network communication system, such as a wireless communication system that uses SKYPE for voice over Internet protocol (VoIP) communications. If the service system using the invention does not have a system 12 (such as the point-to-point systems), or the system 12 does not have the T2 mechanism, then the time T1 of the wireless phone of the second user 13 is not restricted to be smaller than T2.

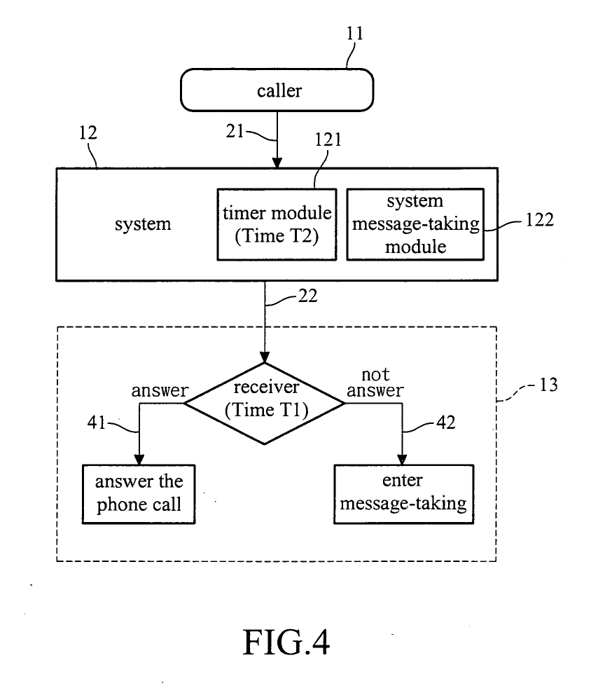

In FIG. 4, the embodiment in FIG. 3 is applied to a mobile communication system. This embodiment is applied to a mobile communication system, such as the GSM, General Packet Radio Services (GPRS), and the Code Division Multiple Access (CDMA). In general, the system includes a first user 11, a service provider system 12, and a second user 13. The system 12 is provided with a system message-taking module 122. The operation principle of the mobile communication using this embodiment is as follows.

The first user sends out a signal (step 21). When the first user 11 wants to communicate with the second user 13, the first user 11 emits a signal.

The system transfers the signal to the second user (step 22). The signal emitted by the first user 11 is first received by the system 12, and then transferred to the second user 13 by the system 12.

The second user answers the incoming call signal (step 41). When the second user 13 receives the incoming call message emitted by the system 12 and the user answers the call, then the first user 11 and the second user 13 can communicate directly.

The second user enters the message-taking mode (step 42). After the second user 13 receives the incoming call signal emitted by the system 12 and the user does not answer within a time T1, then the wireless phone of the second user 13 automatically enters the message-taking function.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of providing an electronic answering function to a wireless phone, comprising the steps of:
setting a time T1;
receiving an incoming call signal; and
when the incoming call signal is now answered by a user within the time T1, answering the incoming call signal by the wireless phone and switching the wireless phone to a message-taking function.

2. The method of claim 1, wherein the wireless phone is a mobile phone.

3. The method of claim 1 further comprising the step of sending an incoming call notification to notify the user when the wireless phone receives the incoming call signal.

4. The method of claim 3, wherein the incoming call notification is through rings.

5. The method of claim 3, wherein the incoming call notification is through vibrations.

6. The method of claim 1, wherein the message-taking function stores the voice signal of the caller in a memory module.

7. The method of claim 6, wherein the memory module is non-volatile memory.

8. The method of claim 1, wherein the message-taking function stores the voice signal of a caller in a memory card slot with a secure digital (SD) card, a compact flash (CF) card, a memory stick (MS), or a smart media (SM) card.

9. The method of claim 1, wherein the incoming call signal comes from a system emission end.

10. The method of claim 1, wherein the time T1 is set between 0 and 15 seconds.

11. The method of claim 1, wherein the time T1 is set to be smaller than a time T2 on a system.
